(19) United States
(12) Patent Application Publication
(10) Pub. No.: US 2004/0229694 A1
(43) Pub. Date: Nov. 18, 2004

(54) Control device of combinatorial key operations

(75) Inventor: Chiu-Hao Cheng, Chung Ho City (TW)

Correspondence Address: BACON & THOMAS, PLLC, 625 SLATERS LANE, FOURTH FLOOR, ALEXANDRIA, VA, 22314

(73) Assignee: Zeroplus Technology Co., Ltd.

(21) Appl. No.: 10/679,350

(22) Filed: Oct. 7, 2003

Related U.S. Application Data
(62) Division of application No. 10/107,458, filed on Mar. 28, 2002, now abandoned.

(30) Foreign Application Priority Data
Sep. 4, 2001 (CN) 01 1 10543.7

(51) Int. Cl. A63F 13/00

(52) U.S. Cl. 463/37

(57) ABSTRACT

The present invention discloses a game controller for a game host. The control circuit inside the game controller is in electrical connections with a plurality of keys. When a particular key or several keys are depressed simultaneously, a program code enters a setting mode to set a key combination for generating a distinct programmable instruction output. This is particularly useful in helping users save time to remember or use specific programmable instruction keys by operating the original keys on the game controller.

### BACKGROUND OF THE INVENTION

1. Field of Invention

The invention relates to a same controller with combinatorial key instructions. More specifically, the invention relates to a game controller that use keys on an existing controller and their combinations to set other instruction outputs so that there are more programmable output functions in the controller. With the invention one can save the cost for making the PROG key on the traditional controller.

2. Related Art

Along with the progress in electronics technology researches of various electronic devices do not only aim at optimal efficiency but also achieving light and compact products that require low costs. For example, how to lower the cost for control devices with multiple key switches, such as joysticks, game boys, and remote controls, has become an important topic in the field.

Conventional controllers often require users to enter different key combinations or to depress a single key repeatedly in a game. Therefore, programmable controllers have been proposed to use a single key to represent a series of programmable instructions. It is implemented by assigning programmable instructions of a series of key combinations to an existing key or an additional key on the controller.

As shown in FIG. 1, the programmable game controller commonly seen in the prior art has an additional PROG key. A programmable instruction is programmed by first pressing the PROG key, an assigned key, the desired key combination, and finally the PROG key again. It is schematically represented by the following procedure:

[PROG]→[Assigned Key]→[Special Effect]→[PROG].

With reference to FIG. 2, when the control circuit 12 receives the first PROG key signal, the same controller enters the PROG setting mode and receives a key signal of the assigned key. After receiving the second PROG key signal, the control circuit 12 stores the special effect keys and completes the setting procedure. During the PROG setting S mode, the game controller does not enter any instruction to the game host. For example, the procedure [PROG]→[A]→[Up→Right→A→B]→[PROG] means that the key A is set as the instruction [Up→Right→A→B]. Therefore, if the key A is depressed during the game, the game controller outputs the programmable instructions equivalent to [Up→Right→A→B] to the game host.

However, the above-mentioned techniques have their drawbacks. If one sets programmable instructions of a key combination to an existing key, then the original function of the existing key disappears. If one sets programmable instructions to additional keys (P1, P2), then the manufacturing cost of the game controller is higher. The additional keys are also unnecessary when not in use. Thus, how to minimize the number of necessary keys on the controller while providing programmable instructions of a plurality of keys without requiring users to learn complicated operation skills is an important problem to be solved.

### SUMMARY OF THE INVENTION

A primary object of the invention is to provide a game controller that utilizes the simultaneous action of several existing controller keys to trigger the same setting function as the PROG key in conventional controllers.

Another object of the invention is a game controller that, under the simultaneous action of a combination of two keys, enters the PROG setting mode to assign programmable instructions to a particular key or a plurality of keys.

In wake of drawbacks and inconvenience in the operations of conventional devices, particularly when the cost increases with the number of keys or the users have to memorize key combinations, the invention provides a controller that can output different programmable instructions by the depression of a particular key or the simultaneous action of a certain key combination. The game controller provides simpler key operations and settings of more programmable instruction outputs. Users therefore do not need to memorize the combinations of keys for particular programmable instructions.

### BRIEF DESCRIPTION OF THE DRAWINGS

The present invention will become more fully understood from the detailed description given hereinbelow illustration only, and thus are not limitative of the present invention, and wherein:

FIG. 1 is a top view of a conventional programmable controller

FIG. 2 is a circuit block diagram of the controller in FIG. 1

FIG. 3 is a top view of the disclosed programmable controller

FIG. 4 is a circuit diagram of an embodiment and

FIG. 5 is a circuit block diagram of another embodiment.

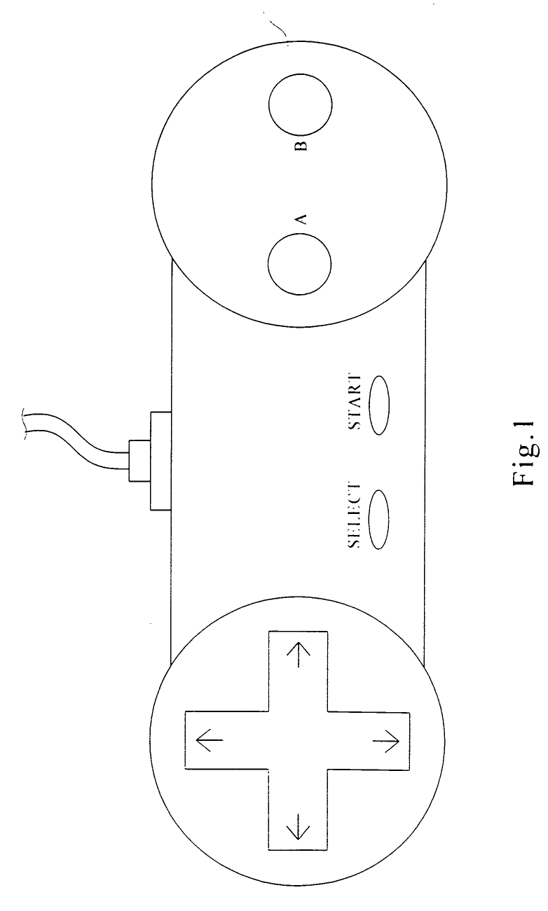

### DETAILED DESCRIPTION OF THE INVENTION

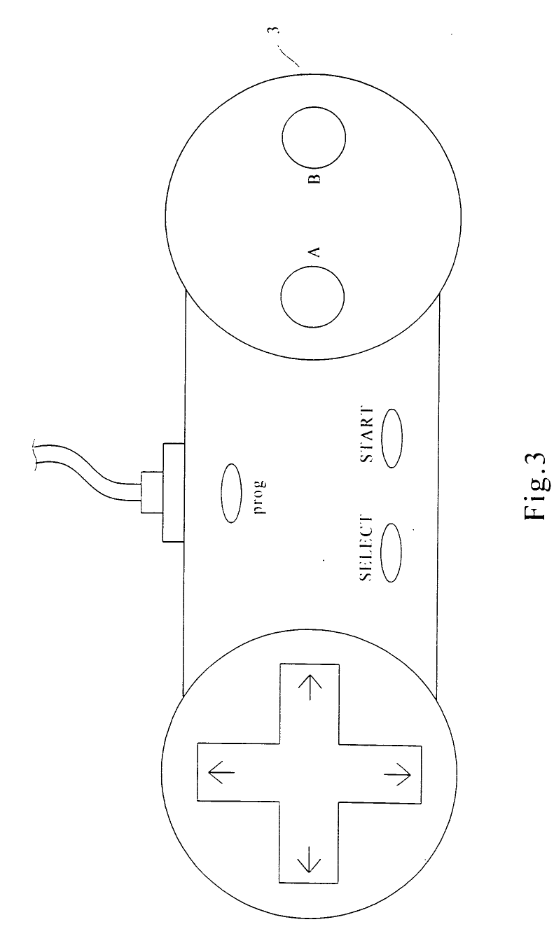

With reference to FIG. 3, the disclosed programmable controller has the usual direction keys. Select and Start keys, and keys A and B as conventional controllers and does not have additional keys (such as P1 and P2).

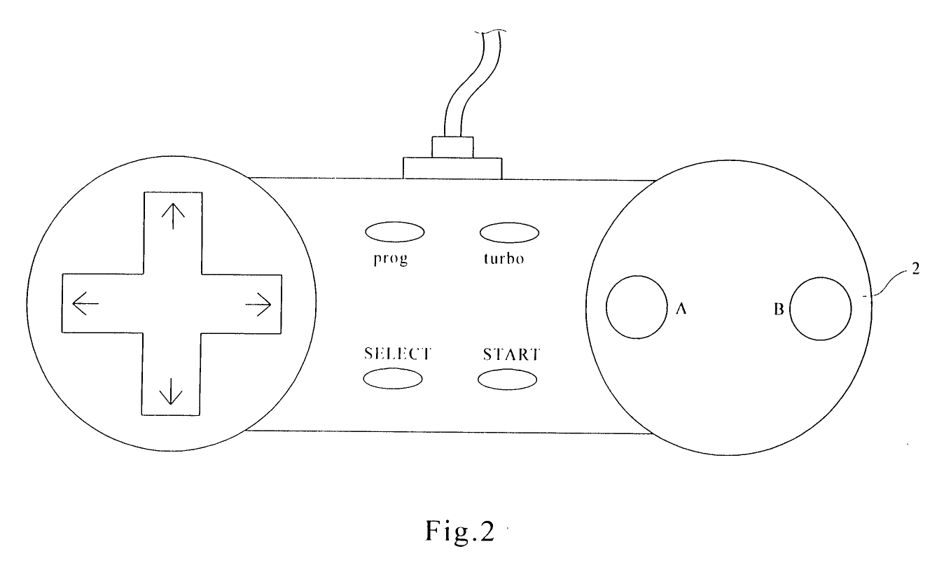

As shown in FIG. 2, the switches 11 are digital switches with two levels H/L. When an individual digital switches 11 is depressed independently, a distinct instruction is output, just like one in a conventional controller. In a preferred embodiment of the invention, the game controller contains a control circuit, which is in electrical communications with a plurality of digital switches and the status of each switch is output to a game host. When a plurality of predetermined digital switches 11 is simultaneously depressed (such as keys A and→together), the control circuit is triggered to execute a PROG setting mode (programmable planning). Before a detailed operational explanation of the disclosed PROG function, we have to first define the following two symbols:

‘+’ means that the two keys on both sides of the symbol are depressed simultaneously. For example, [A+B] means that the keys A and B are depressed together.

‘→’ means that the two keys on both sides of the symbol are depressed successively.

Referring to FIG. 3, the PROG key is preserved in the first preferred embodiment. The setting procedure is as follows:

[PROG]→[A combination of several assigned keys]→[Special effect]→[PROG].

When the control circuit 12 receives the first PROG key signal, it enters the PROG setting mode and receives the key signals of assigned keys. After receiving the second PROG key signal, the control circuit 12 stores the special effect and finishes the PROG setting procedure. For example, [PROG]→[A+B]→[Up→Right→A→B]→[PROG] means that the function of A+B is set as the instruction combination [Up→Right→A →B]. Therefore, if one depresses A+B during the game, the programmable controller 2 outputs the programmable instructions [Up→Right→A→B] to the game host.

In a second embodiment of the invention, the PROG key is removed and replaced by combinatorial keys. The setting procedure is as follows:

[A+→ ]→[A combination of several assigned keys]→[Special effect]→[A+→]

When the control circuit 12 receives the first [A−→] key signal, it enters the PROG setting mode and receives the key signals of assigned keys. After receiving the second [A−→] key signal, the control circuit 12 stores the special effect and finishes the PROG setting procedure. For example, [A−→]→[→−↓]→[Up→Right→A→B]→[A+→] means that the function of the key combination [→+↓] is set as the combination [Up→Right→A→B]. Therefore, if one depresses [→+↓] during the game, the programmable controller 2 outputs the programmable instructions [Up→Right→A→B] to the game host. In this method, the original functions of the keys → and ↓ are not lost while fewer keys are needed to enter the instructions for a special effect.

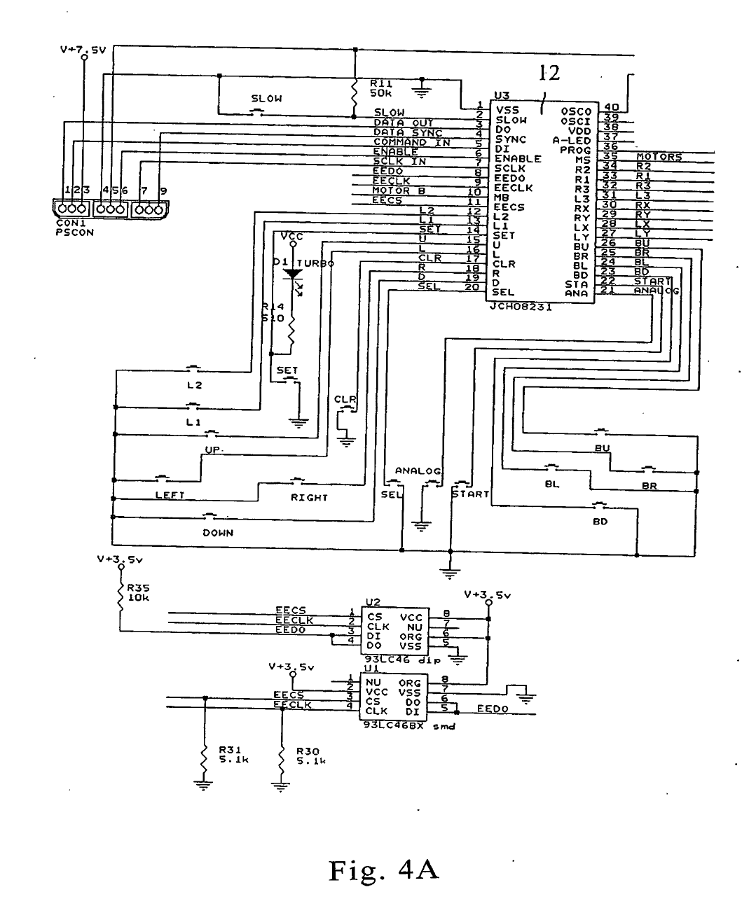

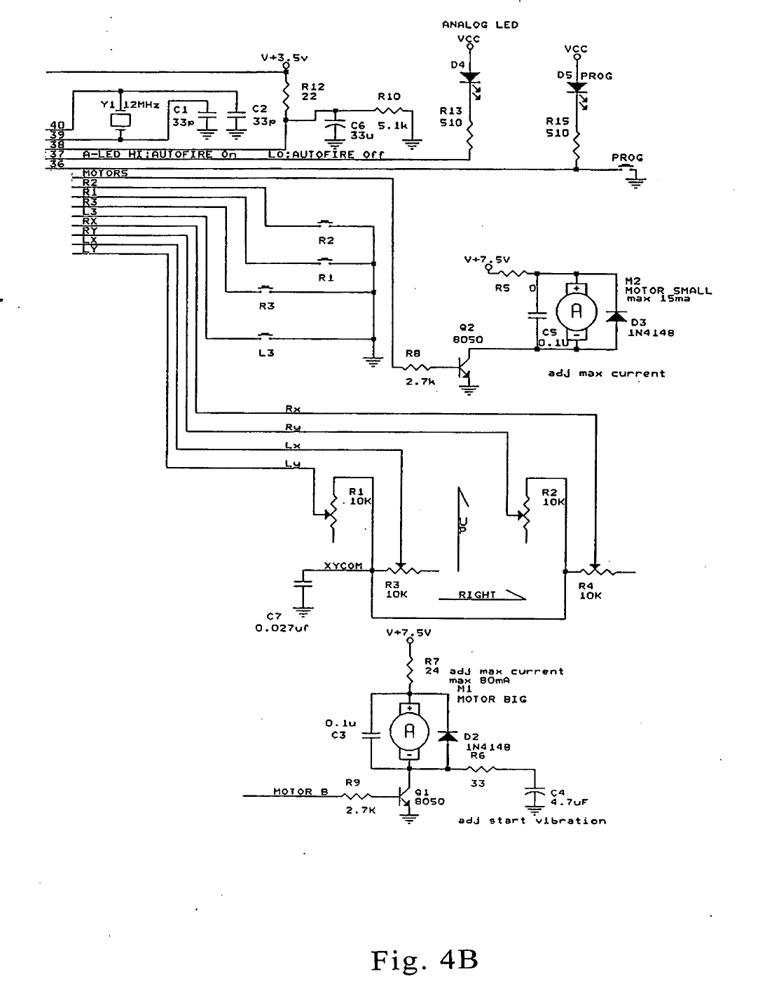

With reference to FIG. 4, the control circuit 12 is implemented by a JCH08231 IC (Integrated Circuit). It is a general programmable controller, which receives the level changes of a plurality of switches to output the instruction of each key to the game host. According to this embodiment, the control circuit 12 is controlled by program codes to run the PROG setting mode. After completing the PROG setting procedure through key operations, the control circuit 12 outputs the key combination for the special effect to the game host when the user simultaneously depress the assigned key combination.

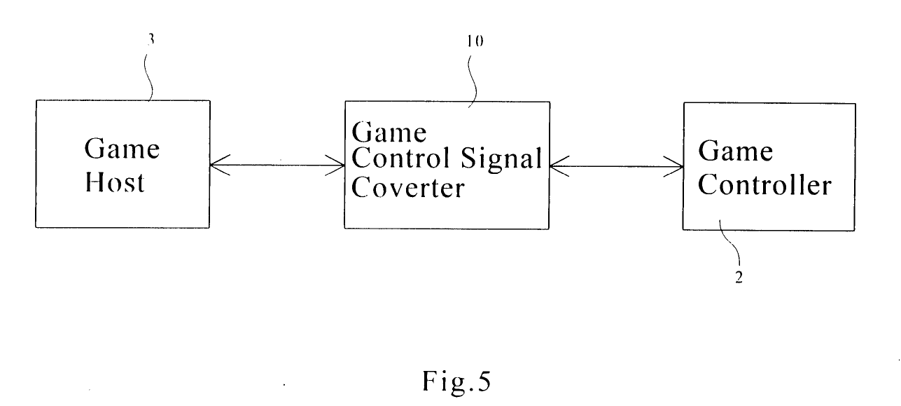

With reference to FIG. 5, in another embodiment of the invention, the control circuit can become an independent game control signal converter 10, electrically connected between the game host 3 and the game controller 2. The control circuit in the game control signal converter 10 receives the statuses of whether keys on the game controller 2 are depressed. The control circuit can run the PROG setting mode. It is featured in that the PROG setting follows the procedure of entering a PROG switch key, assigned keys, special effect keys, and the PROG switch key. The special effect keys include a plurality of instructions. The PROG switch key can be a single key or a predetermined key combination consisting of at least two keys. The assigned keys contain at least two keys in action. When the control circuit completes the setting in the PROG setting mode, the special effect keys are output to the game host 3 when the control circuit receives the signal that the assigned keys on the game controller 1 are depressed.

Effects of the Invention

The game controller disclosed herein uses a plurality of digital switches to set different programmable instructions, simplifying the key operations of the game controller and providing more instruction outputs. It is particularly useful in assigning some particular key combination to a set of keys without replacing their original functions. The invention does not need unnecessary keys and thus effectively reduces the manufacturing cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. (Canceled)

2. (Canceled)

3. (Canceled)

4. (Canceled)

5. A game controller, including a control circuit in electrical connection with a plurality of keys having game functions and arranged to output a depressed status of each of the keys to a game host, the control circuit running a program setting mode in which a plurality of said game functions are assigned to a single assigned one of said keys, wherein the game controller is characterized in that:
said control circuit is arranged to enter said program setting mode upon depressing of said PROG key, and to assign said game functions to a combination of assigned keys when said pressing of said PROG key is followed by simultaneous pressing of at least two of said keys, followed by pressing of said PROG key to exit the program setting mode, thereby enabling assignment of a plurality of game functions to said at least two of said keys without depriving individual ones of said plurality of keys of their original game functions; and, wherein, after completing the setting procedure in the program setting mode, the control circuit outputs the game functions to the game host upon receiving the signal that said at least two of said keys have been simultaneously depressed.
